(19) United States
(12) Patent Application Publication
(10) Pub. No.: US 2021/0269053 A1
(43) Pub. Date: Sep. 2, 2021

(54) System to prevent car crash at intersection with active surveillance

(71) Applicant: Mirza Faizan, (US)

(72) Inventors: Mirza Faizan, Irving, TX (US); Mirza Rizwan, Patna (IN); Azal Amer, Dallas, TX (US); Ryan Xie, Dallas, TX (US); Connor Price Gearey, Dallas, TX (US); Nikitha Thoduguli, Allen, TX (US); Rishab Sidamshetty, Dallas, TX (US); Shreeya Madhavanur, Dallas, TX (US); Ashton Rischer, Desoto, TX (US)

(21) Appl. No.: 17/184,967

(22) Filed: Feb. 25, 2021

Related U.S. Application Data
(60) Provisional application No. 62/982,632, filed on Feb. 27, 2020.

(51) Int. Cl. B60W 50/14; B60Q 9/00; B60R 11/04; H04N 5/225; B60R 25/30; B60R 25/31

(52) U.S. Cl. CPC B60W 50/14; B60Q 9/008; B60R 11/04; B60W 2050/146; B60R 25/305; B60R 25/31; H04N 5/2252

(57) ABSTRACT

A vehicle collision warning and avoidance system including a vehicle that includes one or more sensors, one or more cameras configured with an extended rod to monitor the exact location and the speed of the other vehicles to monitor for a collision condition, and visual monitoring display system configured to emit a warning signal to warn a vehicle driver about the collision condition, the internal warning signal system including at least one warning device configured to emit the warning signal, and a processor configured to detect an exit condition using a signal received from the one or more sensors and the one or more cameras in response to the collision condition.

### TECHNICAL FIELD

The present invention relates to the intersection vehicle collision avoidance system, and more particularly to position detection, collision warning, and collision avoidance systems.

### BACKGROUND OF THE INVENTION

Automobile accidents are one of the most serious problems, both in terms of deaths and injuries and in financial losses as a result of such accidents. Studies suggested that more than 30% of all accidents in the United States occur at intersections. The increase in population and extensive use of automobiles worldwide with the concomitant increased congestion on roadways demands the development of systems for collision elimination. While several advances have been made in vehicle safety such as seatbelts, airbags, and safer automobile structural designing, much room for improvement exists in automotive safety and accident prevention systems.

U.S. Pat. No.7,295,925 discloses an accident avoidance system that includes a positioning system arranged in each vehicle that determines the absolute position of each vehicle and then uses the position information to prevent two or more vehicles from being at the same place at the same time. However, such a system involves the determination of the absolute position of a first vehicle and a second vehicle, information regarding which lane the first and second vehicles are in, weather conditions, accident conditions, and the like. As such, a relatively complex system is disclosed, and an intersection collision avoidance system that is relatively simple and yet reliable desirable.

The prior art systems described above are not reliable for determining, communicating, and providing collision avoidance safety response to predetermined assets and infrared emitting objects in non-line-of-sight conditions such as for the vehicles that are hide because of the other vehicle.

All of these conventional methods/systems or a computer program product, and some other method/system presently known in the art have had some flaws in design or mechanism and lacks precision. Most of the existing devices are not accurate for providing information about the hidden vehicle. Some shortfalls of the existing method/system or a computer program product include manual interference or. In light of this, there is a need for a method/system or a computer program product that overcomes these constraints.

In the light of these facts, it is of great advantage to the safety of the vehicle and its occupants that there is a system to accurately tell the location and speed of the other vehicle. Furthermore, if a system makes its internal calculations and tells the driver if there is a danger for the vehicle at the time of intersection it will save hundreds of lives worldwide. There is a need for a vehicle security system that is designed for position detection, collision warning, and collision avoidance systems.

Further, there is also a need for a vehicle security system that provides an alarm to a driver so that the driver may make a proper decision while intersecting the roads while some embodiments provide a system to give inputs to self-driving vehicles to make safety decisions without human intervention at all.

None of the above inventions and patents, taken either singly or in combination, is seen to describe the present invention as claimed. Thus, a vehicle Safety System from other vehicles at the time of road intersection and solving the aforementioned problems is desired.

Features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

The present invention addresses the issues as discussed above.

### SUMMARY OF THE INVENTION

The object of the present invention is to overcome the disadvantages of the prior arts and provide a vehicle safety system for avoiding a vehicle collision at the time of intersection, wherein the system includes a camera at the top position of an extendable-retractable shaft, the shaft comprising an attachment means adapted to configure an extension and/ or retraction of the shaft too and/or away from the vehicle, wherein the extendable-retractable shaft can extend up to 5 feet above the roof of the vehicle, allowing for the driver to have a 360-degree view of oncoming traffic that would normally be a blind spot. A sensor housing wherein the sensor housing comprising a plurality of sensors adapted to detect the speed of the vehicle, the position of the vehicle, and a visual monitoring displays adapted to receive measurements from the plurality of sensors and camera, wherein the visual monitoring displays includes a processor, a display and an alarm unit, wherein when the vehicle is moving on the road, the visual monitoring displays receive the measurements from the plurality of sensors and generates an alarm when the there is a chance of collision based on measurements received from the sensors and cameras.

According to another object, the vehicle safety systems provide a position detection, collision warning, collision avoidance, and communicating system, wherein the system comprised of one or more cameras, visual monitoring displays, and short-range proximity sensors such as ultrasonic or infrared sensors, wherein the camera with the elongated shaft provide a view of areas not otherwise seen by the driver, and one or more sensors to detect the speed of the vehicle, the position of the vehicle. The visual monitoring display system is positioned inside the vehicle so that the driver can view what the video camera is capturing, and determine whether there is a danger of colliding with an object if the driver proceeds in the current direction.

According to another object of the invention, the system further includes a proximity sensor, wherein the sensor is paired with the camera to detect objects within range and generate audible and visual warnings to the drivers.

According to an embodiment of the present invention, the system is not limited to only the camera or proximity sensor or encompassing a combination of the camera and proximity sensor, provide good localized coverage for detecting objects within a defined proximity, and communicating chance of collision at the time of intersection to the driver to avoid collision between objects within a defined line-of-sight distance.

According to another object of the present invention, the safety system provides automated controls for slowing or stopping or providing audible and/or visual notification to the drives in an event of chances of a collision.

The present invention is a camera-based intersection collision avoidance system with the added advantage of vehicular safety. The camera-based system can be installed on any car post-manufacturing. It is perched on a retractable antenna that can extend up to 5 feet above the roof of the car, allowing for the driver to have a 360-degree view of oncoming traffic that would normally be a blind spot. The same camera scan be used for surveillance as well when the driver is away, to ensure the safety of the car.

There is a need for a system that overcome the prior problems and provide a system that enhances the visibility of a multitude of blind spots which will enable the driver to see over taller cars and longer distance. With such facilitation, the number of car crashes at intersections will go down as the driver will have better intuition on the road. Also, the system will monitor the car's surroundings and can also be used for public surveillance as well.

Other objects, advantages, and features of this invention will become more apparent from the following description.

The details of one or more implementations are set forth in the accompanying description below. Other aspects, features, and advantages of the subject matter disclosed herein will be apparent from the description and the claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

Features, elements, and aspects of the invention that are referenced by the same numerals in different figures represent the same, equivalent, or similar features, elements, or aspects in accordance with one or more embodiments.

The following figure depicts a certain illustrative embodiment of the invention. This depicted embodiment is to be understood as illustrative of the invention and not as limiting in any way.

Referring particularly to the drawing for illustration only and not limitation, there is illustrated:

FIG. 1 is the perspective view of an embodiment of a vehicle with a collision warning system; according to the present invention.

FIG. 2 shows a perspective view of the system according to the present invention.

FIG. 3 is the perspective view of the collision warning system according to the present invention.

FIG. 4 shows the controlled display and alarm unit to be mounted on the dashboard according to the present invention.

FIG. 5 shows the homescreen of the mobile app instead of CDAU according to the present invention.

Drawings - Reference Numerals

| | |
|---|---|
| 8 - Vehicle | |
| 10 - Collision Warning System | 30- Memory |
| 11 - extendable-retractable shaft | 20 - microprocessor |
| 12 - system housing box | 21 - memory |
| 13 - 4 came-rasbox | 22 - CDAU |
| 14 - speed measurement gun | 23 - screen |
| 15 -pan-tilt mechanism | 24 - speaker |
| 16 - shaft supporter | 25 -Visual monitoring display system |
| 17 - slot for shaft | 26 - app home screen |
| 18 - GSM | |
| 19 - battery | 28-Sensors |

### DETAILED DESCRIPTION OF DRAWINGS

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment,” “an embodiment,” “at least one embodiment,” “one example,” “an example,” “for example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The apparatus and method of the present invention will generate warning signals and initiate avoidance maneuvers to minimize the probability of a collision. The warning signals will be generated through the help of one or more 360-degree cameras, speed measurement radar, one or more sensors, Global Positioning System (GPS), and Visual monitoring display system.

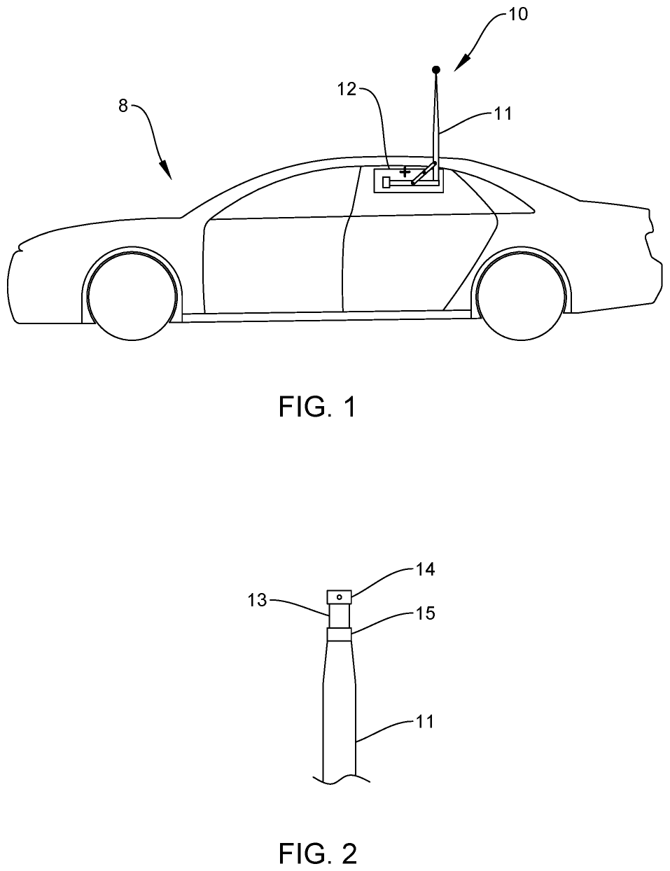

FIG. 1, is the perspective view of an embodiment of a vehicle 8 with a collision warning system 10 as according to the present invention, wherein the vehicle 8 may be any vehicle (e.g., the car, truck, train, the airplane, motorcycle, etc.). In operation, the collision warning system 10, wherein the system includes a system housing box 12, wherein the system housing box includes one or more sensors, one or more cameras, and an extendable retractable shaft 11, wherein the retractable shaft can extend up to 5 feet above the roof of the car, allowing for the driver to have a 360-degree view of oncoming traffic that would normally be a blind spot. The same cameras can be used for surveillance as well when the driver is away, to ensure the safety of the car. Further, the collision warning system 10 warns the vehicle driver at the time of intersection if any approaching hazard before and/or while the vehicle occupants exit the vehicle 8 or when the vehicle turns or intersect, wherein the approaching hazards may include other vehicles and/or pedestrians.

According to an embodiment of the present invention, the collision warning system 10 includes a variety of components that operate together to warn drivers and passengers of a potential hazard(s), wherein the hazard can be from another device that is in the blind spot of the driver.

FIG. 2, according to the present invention, the system further includes a variety of the camera 13 placed at different locations on the vehicle 8 and speed measuring device 14. For example, the collision sensors 14 may couple to the front of the vehicle 8, the back of the vehicle 8, on top of the vehicle 8 with the extendable retractable shaft 11, sides of the vehicle 8 (e.g., doors), and/or the side mirrors, etc. In this way, the collision warning system 10 may enable the driver to have a 360-degree view of oncoming traffic that would normally be a blind spot. The same cameras can be used for surveillance as well when the driver is away, to ensure the safety of the car.

However, in some embodiments, vehicle 8 may only have a collision camera 13, wherein the camera is available at the top of the car with extendable retractable shaft 11, wherein the shaft can extract up to 5 feet high to view hazards approaching from the rear of the vehicle 8 at the time of intersection of the vehicle.

In some situations, the camera might not be able to reach the other vehicle properly, for these situations the camera housing 13 is mounted on a Pan and Tilt mechanism 15 to enable the camera to reach and read the vehicle speed properly.

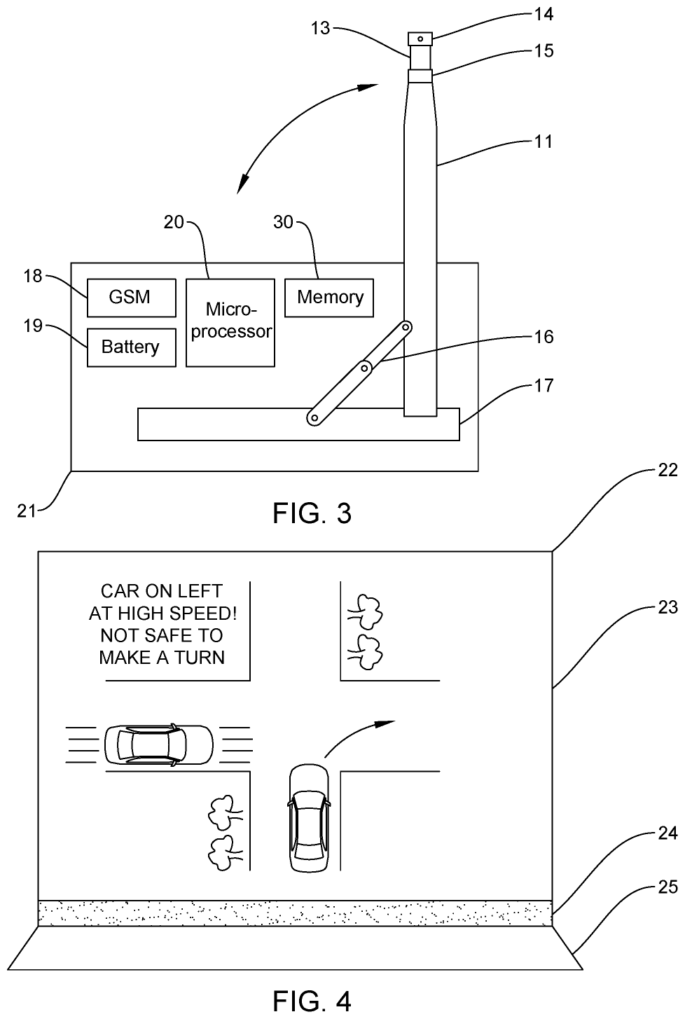

FIG. 3 perspective view of the collision warning system as according to the present invention, In operation, the speed measuring device 14 and the camera box 13 transmit signals (e.g., wirelessly, through wired connections) to a processor 20 (e.g., the computer). The processor 20 may include one or more processors that execute instructions stored on one or more memories 30 to process the signals (e.g., data) received from the speed measuring device 14 and the camera box 13. For example, controller 20 may receive a signal (e.g., data) from an optical camera. The processor 20 may then execute a program stored on memory 30 that recognizes objects (e.g., cars, trucks, bicycles, pedestrians, animals, etc.) in images taken by the optical camera and also receive the information from the speed measuring device i.e Radar. At the time of intersection, if the processor 20 detects any vehicle coming from the backside and there is a chance of collision, the processor 20 executes instructions to a visual monitoring displays adapted to display and an alarm, For example, when the vehicle is moving on the road, the visual monitoring displays receives the measurements from the plurality of sensors and generates an alarm when the there is a chance of collision based on measurements received from the sensors and cameras the driver can decide to decide at the time of intersection to reduce the chances of a collision.

As another example, controller 20 may detect chances of collision in less than 0.1, 0.3, 0.5, 1.0, 1.5 seconds, etc. In some embodiments, controller 20 may continuously receive feedback from the speed measuring device 14 and the camera box 13 enabling the controller 20 to track changes of the potential hazard and determine if the changes alter the hazard condition (e.g., increase the risk of collision, reduce the risk of collision, or remove the risk of collision). These changes may include changes in the speed of hazard 12; changes in the distance between hazard 12 and vehicle 8; changes in the direction of travel of hazard 12; etc. For example, threshold distances, threshold speeds, etc. may be stored in the memory 30 and accessed by the processor 20 to determine whether a hazard condition exists. Furthermore, in some embodiments, the controller 20 may simultaneously receive feedback from multiple speed measuring device 14 and the camera box 13 and enabling the controller 20 to more accurately identify a hazard 12 (e.g., cross-reference, verify) and determine if a hazard condition or situation exists. Furthermore, the system may display a timer, that may indicate the severity of the situation in timing means and this timing may be further indicated by a colour code, such as 1.5 seconds may be represented by green, 1 second may be represented by orange and 0.5 seconds may be represented by red colour. This way the entire vehicle may reflect the sensitive situation to plurality of people.

FIG. 4 is an inside view of an embodiment of a vehicle with a collision warning system 10, wherein the warning is displayed at visual monitoring displays. As explained above, once a hazard condition is identified the controller 20 activates an internal warning signal system to prompt the warning message on the display or audio via a speaker 24 of a CDAU 22, wherein the warning message communicates in one or more ways with the vehicle driver (e.g., visual, audio, vibration). For example, one warning may be a display (e.g., center console display, dashboard display, seat display, heads-up display) within the vehicle that provides a warning message. For example, the message may be a written message that flashes, scrolls, etc. on the display. In some embodiments, the message may be a picture that illustrates the vehicle and the potential collision with a symbol (e.g., dot, vehicle symbol, pedestrian symbol) on screen 23. The display may also illustrate the location of the potential collision with respect to the vehicle. Moreover, in some embodiments, the controller 20 may be able to identify the type of hazard and then display the specific type of hazard (e.g., pedestrian, vehicle, animal) on the screen 23, thus providing the vehicle driver with more situational awareness.

In an embodiment of the present invention, the vehicle may be equipped with one or more communication network systems to provide real-time data transmission and communication of relevant information, which the user may want to share with one or more emergency contacts.

Furthermore, aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should, therefore, be regarded as exemplary only, with the scope of the invention determined solely by the claims.

According to an embodiment of the present invention, If the driver is away, a built-in GSM chip will allow the module to transmit a video feed of the car that helps the user to view oncoming traffic in the driver's blind spot.

According to another embodiment of the invention, the camera also allows for surveillance monitoring of the vehicle when the driver is away from the vehicle and giving them a live feed blind spot of the surroundings of the vehicle.

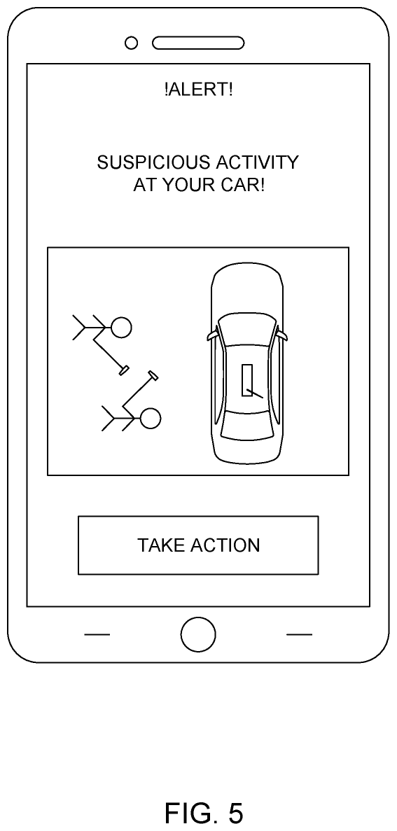

FIG. 5 shows a mobile that depicts visual monitoring displays with the alarm and the system to navigate to reduce collision according to the present invention.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the Internet. The computer further comprises a microprocessor. The microprocessor is connected to a communication bus. The computer also includes a memory. The memory may be Random Access Memory (RAM) or Read-Only Memory (ROM). The computer system further comprises a storage device, which may be a hard-disk drive or a removable storage drive, such as, a floppy disk drive, optical disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as the reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

To process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C,” “C++,” “Visual C++,” Java, and “Visual Basic.” Further, the software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various implementations of the systems and techniques described here can be realized in digital electronic circuitry, integrated circuitry, specially designed ASICs (application-specific integrated circuits), computer hardware, firmware, software, and/or combinations thereof. These various implementations can include implementation in one or more computer programs that are executable and/or interpretable on a programmable system including at least one programmable processor, which may be special or general-purpose, coupled to receive data and instructions from and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus, and/or device (e.g., magnetic discs, optical disks, memory, Programmable Logic Devices (PLDs)) used to provide machine instructions and/or data to a programmable processor. The PLD's may be configured with timer system also to indicate the severity of the failure.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A person having ordinary skills in the art will appreciate that the system, modules, and sub-modules have been illustrated and explained to serve as examples and should not be considered limiting in any manner. It will be further appreciated that the variants of the above-disclosed system elements, or modules and other features and functions, or alternatives thereof, may be combined to create other different systems or applications.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

Implementations of the embodiments may be made in hardware, firmware, software, or various combinations thereof. The embodiments may also be implemented as instructions stored on a machine-readable medium, which may be read and executed using one or more processing devices. In one implementation, machine-readable media may include various mechanisms for storing and/or transmitting information in a form that can be read by a machine (e.g., a computing device). For example, machine-readable storage media may include read-only memory, random access memory, magnetic disk storage media, optical storage media, flash memory devices, and other media for storing information, and machine-readable transmission media may include forms of propagated signals, including carrier waves, infrared signals, digital signals, and other media for transmitting the information. While firmware, software, routines, or instructions may be described in the above disclosure in terms of specific exemplary aspects and implementations performing certain actions, it will be apparent that such descriptions are merely for the sake of convenience and that such actions result from computing devices, processing devices, processors, controllers, or other devices or machines executing the firmware, software, routines, or instructions.

Furthermore, aspects and implementations may be described in the above disclosure as including particular features, structures, or characteristics, but it will be apparent that every aspect or implementation may or may not necessarily include the particular features, structures, or characteristics. Further, where particular features, structures, or characteristics have been described in connection with a specific aspect or implementation, it will be understood that such features, structures, or characteristics may be included with other aspects or implementations, whether or not explicitly described. Thus, various changes and modifications may be made to the preceding disclosure without departing from the scope or spirit of the invention, and the specification and drawings should, therefore, be regarded as exemplary only, with the scope of the invention determined solely by the appended claims.

What is claimed is:

1. A collision avoidance system, comprising:
one or more cameras disposed at a vehicle with an extended retractable shaft equipped with said collision avoidance system, wherein each of the one or more cameras having a 360 degree of view with the help of the extended retractable shaft;
one or more sensors disposed at the vehicle to determine the speed and distance of the other vehicles; and
a processor configured to
receive information from the one or more sensors and the cameras to detect a location of collision condition; and
in response to detecting the collision condition, generate a signal to cause a display system configured to emit a warning signal to warn the vehicle driver about the collision condition.

2. The system as claimed in claim 1, further comprising an image processing module, wherein the image processing module is connected with the processor.

3. The system as claimed in claim 1, wherein the one or more cameras are connected with an image processing module.

4. The system as claimed in claim 1, wherein the one or more cameras are high definition panorama cameras with night vision function.

5. The system as claimed in claim 1, wherein the generated warning signal is a light beam.

6. The system as claimed in claim 1, wherein the warning signal is an auditory warning signal.

7. The system as claimed in claim 1, further comprising a warning device to provide a vibratory warning signal.
